(19) United States
(12) Patent Application Publication
(10) Pub. No.: US 2023/0222412 A1
(43) Pub. Date: Jul. 13, 2023

(54) ANTICIPATING TRANSPORTATION ON DEMAND NEEDS

(71) Applicant: MOOVIT APP GLOBAL LTD., Ness Ziona (IL)

(72) Inventors: Binyamin GALON, Tzur Hadassah (IL); Michael SORANI, Ramat Gan (IL); Nir BEZALEL, Rehovot (IL); Roy BICK, Kfar Saba (IL); Vadim VAKSIN, Rehovot (IL); Doron Nissim TVIZER, Ness Ziona (IL); Noga BARAK, Tel Aviv (IL); Gil Emanuel FUCHS, Ness Ziona (IL)

(21) Appl. No.: 18/101,234

(22) Filed: Jan. 25, 2023

Related U.S. Application Data
(63) Continuation of application No. PCT/IL2021/050895, filed on Jul. 23, 2021.
Application No. PCT/IL2021/050895 is a continuation-in-part of application No. PCT/IL2021/050894, filed on Jun. 22, 2021.
Application No. PCT/IL2021/050894 is a continuation-in-part of application No. PCT/IL2021/050778, filed on Jun. 24, 2021.
Application No. PCT/IL2021/050778 is a continuation-in-part of application No. PCT/IL2021/050499, filed on Apr. 30, 2021.
(60) Provisional application No. 63/056,640, filed on Jul. 26, 2020.

(51) Int. Cl. G06Q 10/0631; G06Q 50/30

(52) U.S. Cl. CPC G06Q 10/06315; G06Q 50/30

(57) ABSTRACT

Embodiments are provided for anticipating a demand for transportation on demand vehicles operating in a geographical region of interest, including a non-transitory computer-readable medium including instructions that when executed by at least one processor, cause it to perform operations, which may include: determining a plurality of spatiotemporal service need feature vectors characterizing a transportation need in the geographical region of interest over a first time period; determine a time-resolved regression function based on the plurality of spatiotemporal service need feature vectors; applying the time-resolved regression function to determine, from the plurality of spatiotemporal service need feature vectors, a plurality of anticipated spatiotemporal service need feature vectors for a second time period, subsequent to the first time period; and using the plurality of anticipated spatiotemporal service need feature vectors to determine a measure of anticipated transportation need in the geographical region of interest for the second time period.

### RELATED APPLICATIONS

This application claims benefit under 35 U.S.C. 119(c) of U.S. Provisional Application 63/056,640 filed Jul. 26, 2020 and is a Continuation in Part of PCT International Application PCT/IL2021/050499 filed Apr. 30, 2021 and is a Continuation in Part of PCT International Application PCT/IL2021/050778 filed Jun. 24, 2021, and is a Continuation in Part of PCT International Application PCT/IL2021/050894 filed Jul. 22, 2021, the disclosures of which are incorporated herein by reference.

### FIELD

Embodiments of the disclosure relate to managing vehicle resources to provide a modern population of users with Mobility as a Service (MaaS).

### BACKGROUND

The increase in the global and national populations and the sophistication and variety of daily, leisure, and business activities in which modern populations regularly engage has reconfigured population distributions and transportation needs of the populations. Modern population distributions are characterized by densely populated cities that are associated with surrounding satellite regions of various types and usually evidence unparalleled growth in population density and geographical spread. The cities typically comprise a plurality of different regions characterized by different activities. The different regions may for example comprise a central transportation hub comprising a central train or bus station, high-density, high-rise residential zones, a financial district, a commercial downtown business district, shopping malls, and an entertainment district. Satellite regions of a city typically include residential areas inhabited by populations of various socioeconomic profiles, such as upscale suburbs, walled communities, rural and blue-collar suburbs, and all too often urban slums, and may include an airport and agricultural regions. The cities may themselves be part of a continuous urban or industrially developed area referred to as a “conurbation”. The various cities and satellite regions typically exhibit different diurnal, daily, monthly, and/or seasonal patterns of large and small, highly labile population movements into, out from, and within the regions, and inhabitants and visitors to the regions experience different transportation needs.

To serve the transportation needs of the “reconfigured” modern society, legacy mobility modes of transportation, such as active transport modes (walking and pedal bicycling), conventional public transportation systems (PTS), and privately owned vehicles, have been reinforced by a host of additional and varied, relatively new modes of transportation, and systems of making the new and legacy modes of transportation available to users. Today a modern mobility consumer may have available for use not only a privately owned vehicle, and a legacy public transport system (PTS), but various transport on demand (TOD) vehicles for hire such as taxis, limousines, buses, rickshaws and Jeepneys, and various types of personal dockless conveyances, such as e-bikes, e-scooters small dockless cars.

The density and ubiquity of the various modes of legacy and burgeoning new modes of transportation not only serve the needs of a modern population but also create new demands and burdens that stress the society that they serve and the environment in which they operate. Integrating and managing the various modes of transportation and associated mobility resources to serve the needs of society has led to understanding and managing the provision of transportation resources as mobility as a service (MaaS). Implementing the concept to provide a satisfactory quality of service (QoS) that answers the different mobility needs of society is a multivariate complex task.

### SUMMARY

An aspect of an embodiment of the disclosure relates to providing a MaaS management system, also referred to as “Moovit-Man”, for managing the provision of TOD vehicles to service demands of a population of users. Moovit-Man comprises executable instructions and/or data, hereinafter also referred to as software, required to provide functions that Moovit-Man provides a user, and comprises and/or has access to any of various processors, memories, and communications network entities and systems required to support Moovit-Man functions. Optionally Moovit-Man is at least partially cloud based and may comprise a cloud based infrastructure of compute resources configured to support functions that Moovit-Man provides a user.

In an embodiment Moovit-Man comprises software executable to scan a geographical area of interest (GROI) and identify zones of interest (ZOIs) that exhibit transportation needs which may be serviced by and benefit from provision of TOD vehicles. A transportation need which may benefit from provision of TODs may by way of example be a time dependent need to reduce traffic congestion, a dearth of transportation options for a first or last mile service, or inadequate accessibility, for example as a result of meandering rather than direct routes for physically reaching a location of desired goods, services or entertainment. Scanning to determine a ZOI in a GROI for a given transportation need optionally comprises determining a spatiotemporal geofence that bounds the ZOI as a spatiotemporal volume whose geographic shape and size may be time dependent and within which the transportation need defining the ZOI may be considered to exist. A geofence delimits a spatial cross section of a spatiotemporal geofence at a given time and is a boundary surrounding a geographical area that at the given time exhibits the transportation need for which the spatial temporal geofence is defined. Unless otherwise indicated explicitly or by context, reference to a geofence is considered to reference a temporal cross section of a spatiotemporal geofence. Scale of time dependence of a spatiotemporal geofence may be hourly, daily, monthly, and/or seasonal.

In accordance with an embodiment, a ZOI geofence for a given transportation need may be determined heuristically and/or analytically. A heuristic geofence may be determined by adopting a neighborhood, municipal, administrative, or otherwise arbitrary boundary. An analytical ZOI geofence may be determined by processing a spatiotemporal service need feature (SNEF) vector optionally comprising a component providing a geographic location, a component providing a time stamp, and at least one component advantageous for determining a value of a metric that provides a measure indicative of an intensity of the given transportation need.

In an embodiment an analytical ZOI for a given transportation need may be determined by clustering SNEF vectors as a function of their respective locations, time stamps, and a feature or features indicative of the need. A ZOI geofence for the transportation need may be determined as a boundary of a spatiotemporal volume that encloses an inordinately large concentration of the clustered SNEFs. In an embodiment processing a SNEF vector to determine a ZOI geofence may comprise tiling the GROI into a plurality of regular or irregular geographical tiles, also referred to as “geotiles”, and evaluating for each of the geotiles the SNEF vector. The geofence may be substantially coincident with a geographic isoline of a function of the SNEF vector and/or a derivative of a function of the SNEF vector.

In an embodiment Moovit-Man comprises software for provisioning TOD vehicles to users in a determined ZOI based on a dynamic map, optionally referred to as a “tempest map”. A tempest map maps current locations of TOD vehicles in the GROI, or GROI to which the ZOI belongs, and determines distances between a current, source location, of a given TOD vehicle in the ZOI or GROI and a destination location for the given TOD vehicle, in accordance with a trip cost metric (TRICOM).

A TRICOM may be a function of at least one or any combination of more than one of: a beeline distance, BEE-ΔD, between the source and destination locations; a Manhattan distance, MAN-ΔD, between the source and target locations; a trip time, TR-ΔT, to navigate the Manhattan distance; a vehicle operating cost, TR-CST, incurred in making the trip; a measure of inconvenience, MI, caused by making the trip to current passengers of the TOD vehicle and/or reservation passengers, (passengers who are not currently on the TOD vehicle but have reserved a seat on the TOD vehicle); and/or a trip priority (TR-P). An MI may be determined based on at least one or any combination of more than one of added travel time for current passengers, additional delay in pick-up time of reservation passengers, and/or crowding of the TOD vehicle. A trip priority may by way of example be determined as a function of at least one or any combination of more than one of a destination location for a passenger pick-up, drop-off, or passenger profile. A location of a passenger pick-up, or drop-off for a TOD vehicle is optionally referred to as a virtual stop.

In an embodiment Moovit-Man operates to determine QoS and/or effectiveness of a quantity and/or distribution of vehicles in a fleet of TOD vehicles made available to a ZOI in satisfying an identified transportation need associated with the ZOI. Effectiveness of the TOD fleet is optionally determined by monitoring and processing the SNEF feature vector used to identify the transportation need. For example, the SNEF vector may repeatedly be evaluated for geotiles in the ZOI to determine if changes in a component or components of the SNEF vector evaluated for a geotile or geotiles in the ZOI indicate that the transportation need is being satisfactorily serviced by the TOD fleet. If the processed SNEF vector indicates that the traffic need is not responding as hoped for to the quantity and/or distribution of vehicles in the TOD fleet, the quantity and/or distribution of the vehicles may be changed. Effectiveness of a deployment of TOD vehicles in satisfying a transportation service need may be determined by monitoring and accumulating historical data of traffic activity and/or changes in a SNEF vector in response to actual deployment of different spatiotemporal distributions of TOD and analyzing the accumulated data. Effectiveness of a deployment of TOD vehicles in satisfying a transportation service need may be determined responsive to changes in traffic and/or a SNEF vector projected by a model of traffic behavior.

In an embodiment, determined time dependent historical changes in the SNEF vector may be used by Moovit-Man to anticipate and undertake changes in the quantity and/or distribution of vehicles in the fleet of TOD vehicles to support satisfactory performance of the fleet in responding to the transportation need associated with the ZOI.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1A schematically shows a map of a neighborhood of Boston Mass. referred to as Roxbury as an example GROI that is tiled with geotiles and exhibits a ZOI having a first-mile/last-mile transportation need, in accordance with an embodiment of the disclosure;

FIG. 1B shows a flow chart of a procedure that Moovit-Man may execute to identify the ZOI exhibiting the first/last mile need shown in FIG. 1A, in accordance with an embodiment of the disclosure;

FIG. 1C schematically shows the neighborhood of Boston shown in FIG. 1A having ZOIs that are determined by clustering without use of tiling in accordance with an embodiment of the disclosure;

FIG. 1D shows a flow chart of a procedure by which Moovit-Man may determine the ZOIs shown in FIG. 1C, in accordance with an embodiment of the disclosure;

FIG. 1E schematically shows spatiotemporal geofences for the Roxbury neighborhood determined using an algorithm based on that shown in the flow chart of FIG. 1C, in accordance with an embodiment of the disclosure;

FIG. 2A schematically shows a map of Boston Mass. and environs that exhibits a transportation need to improve, “boost”, transportation resources, and ZOIs determined for the transportation boosting need, in accordance with an embodiment of the disclosure;

FIG. 2B shows a flow chart of a procedure that Moovit-Man may execute to identify ZOIs in the Boston area shown in FIG. 2A that may exhibit a need to boost PTS resources, in accordance with an embodiment of the disclosure;

FIG. 2C and FIG. 2D show a flow chart of a procedure that Moovit-Man may execute to determine whether the ZOIs identified in FIG. 2A by the procedure shown in the flow chart of FIG. 2B have transportation boosting (T-Boost) need, in accordance with an embodiment of the disclosure;

FIG. 3A schematically shows a service area established for providing TOD services to the first/last mile ZOI shown in FIG. 1A, in accordance with an embodiment of the disclosure;

FIG. 3B shows a flow chart of a procedure that Moovit-Man may execute to determine a service corridor for a ZOI, in accordance with an embodiment of the disclosure.

FIG. 3C schematically shows a distribution of TOD vehicles and TOD service corridors along which the TOD vehicles travel in the TOD service area service area shown in FIG. 3A, in accordance with an embodiment of the disclosure; and

FIG. 3D shows a flow chart of a procedure that Moovit-Man may execute to assign a TOD vehicle to pick up a user at a virtual stop, in accordance with an embodiment of the disclosure; and

### DETAILED DESCRIPTION

In the discussion, unless otherwise stated, adjectives such as “substantially” and “about” modifying a condition or relationship characteristic of a feature or features of an embodiment of the disclosure are understood to mean that the condition or characteristic is defined to within tolerances that are acceptable for operation of the embodiment for an application for which the embodiment is intended. Wherever a general term in the disclosure is illustrated by reference to an example instance or a list of example instances, the instance or instances referred to, are by way of non-limiting example instances of the general term, and the general term is not intended to be limited to the specific example instance or instances referred to. The phrase “in an embodiment”, whether or not associated with a permissive, such as “may”, “optionally”, or “by way of example”, is used to introduce for consideration an example, but not necessarily a required configuration of a possible embodiment of the disclosure. Unless otherwise indicated, the word “or” in the description and claims is considered to be the inclusive “or” rather than the exclusive or, and indicates at least one of, or any combination of more than one of items it conjoins.

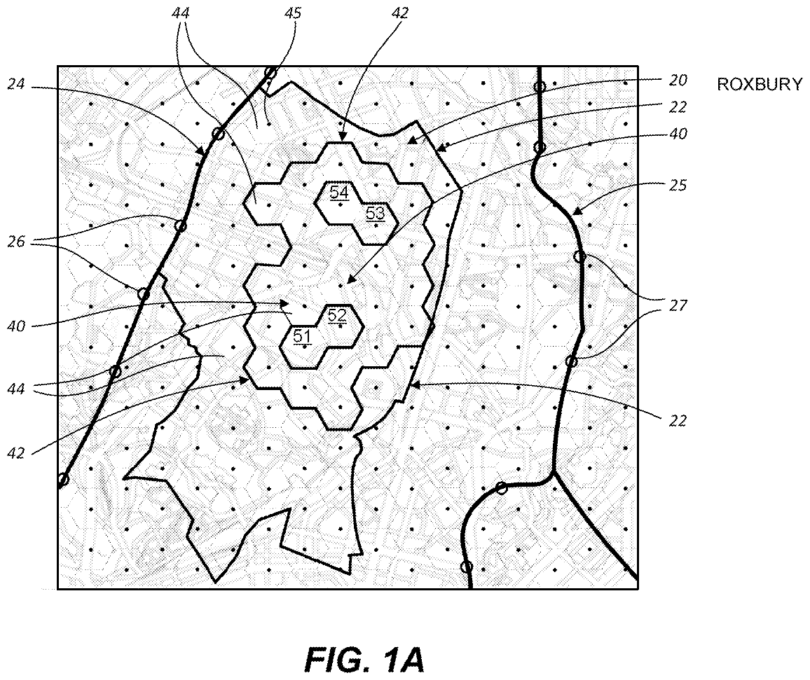

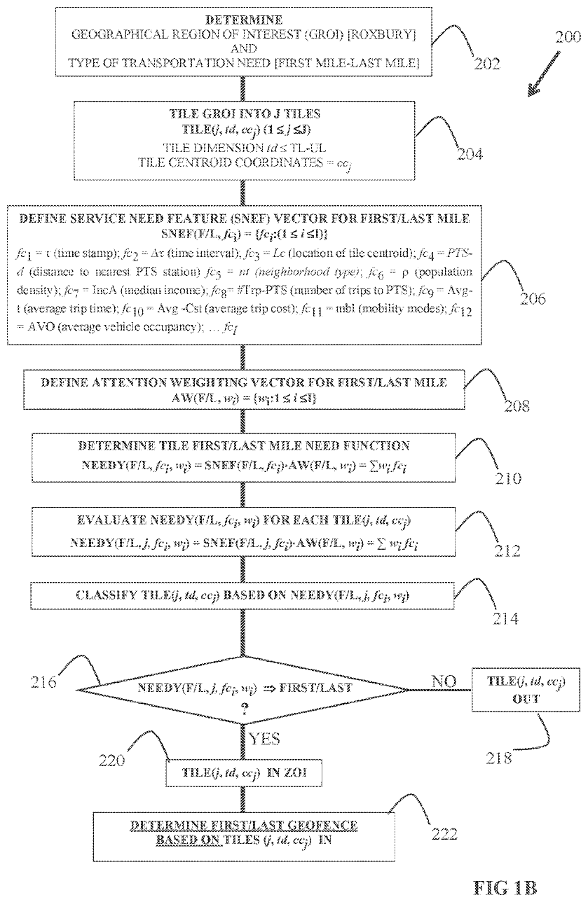

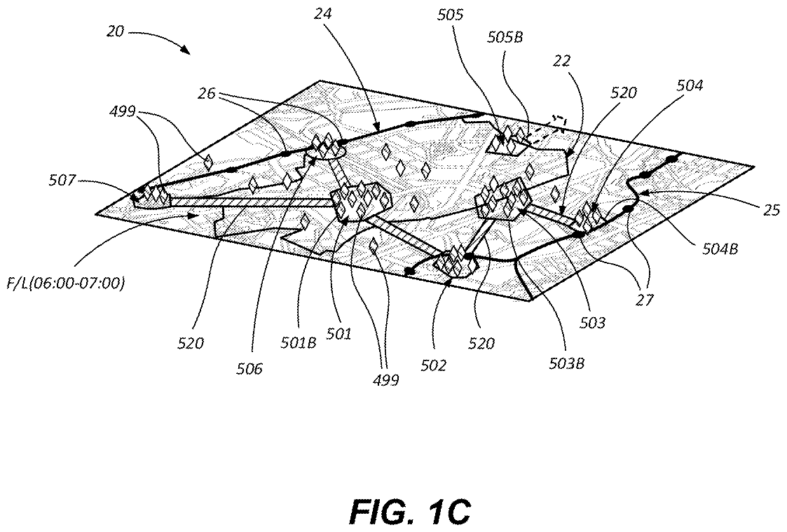

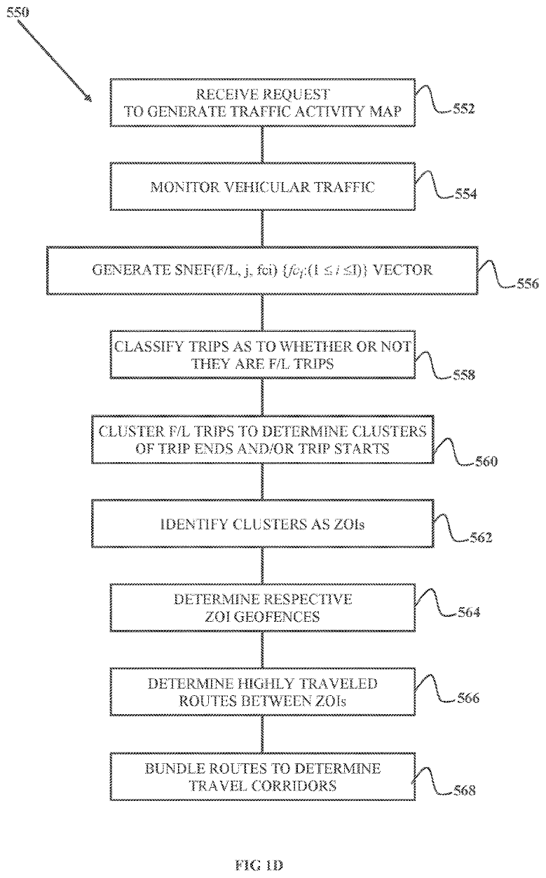

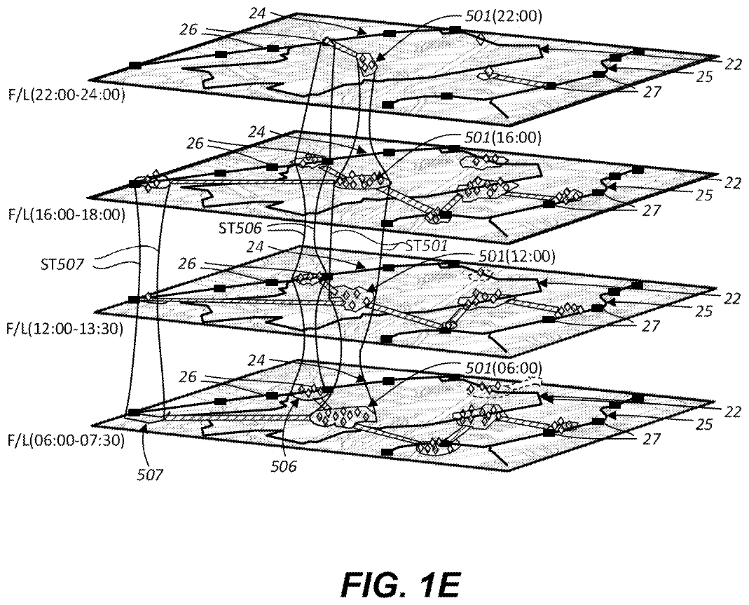

FIG. 1A schematically shows a map of a GROI 20 for which Moovit-Man has by way of example identified a ZOI 40 that exhibits a first-mile/last-mile transportation need and established a geofence 42 that delimits the ZOI, in accordance with an embodiment of the disclosure. GROI 20 is by way of example a neighborhood named, “Roxbury”, that is outlined by a municipal border 22 and is part of the greater Boston area. The greater Boston area, only a portion of which is shown in the figure, may be considered a larger GROI, an “envelope” GROI enclosing the smaller Roxbury GROI 20. Roxbury 20 is located between public transportation lines (PTS) 24 and 25 respectively having PTS stations 26 and 27. In accordance with an embodiment Moovit-Man optionally identifies ZOI 40 and determines its associated geofence 42 by tiling a portion of the greater Boston area that includes Roxbury into a plurality of virtual tiles 44 and processing information for each of the tiles.

FIG. 1B shows a flow diagram 200 that illustrates a tiling procedure, also referred to by the label 200, that Moovit-Man may execute to determine ZOI 40 and geofence 42, in accordance with an embodiment of the disclosure.

In a block 202 of procedure 200 Moovit-Man receives a user request to determine if within a GROI 20 that is the neighborhood of Roxbury in the greater Boston area shown in FIG. 1A there exists a ZOI characterized by a first/last mile transportation need. In response, in a block 204 Moovit-Man tiles at least a portion of the greater Boston area including Roxbury with virtual tiles 44 schematically shown in FIG. 1A. Tiles 44 are optionally identical regular hexagons, with each tile having a perimeter delimiting a region of Boston at a location given by a location of a center 45 of the tile and a tile dimension td equal to a distance between opposite sides of the tile.

Let a particular j-th tile 44 of a total of “J” tiles be represented by TILE(j, td, ccⱼ), also referred to as tileⱼ where ccⱼ represents a geographic location of center 45 of the tile. Optionally td≤ULD where ULD is an upper limit distance that is considered to be a distance that most people would not consider presents a last or first mile difficulty and would find reasonable to traverse by walking or using a dockless conveyance. By way of example ULD may be equal to about a half kilometer.

Optionally in a block 206 Moovit-Man determines a service need feature vector SNEF(F/L, j, fcᵢ)={fcᵢ:(1≤i≤I)} having features fcᵢ for determining whether a given TILE(j, td, ccⱼ) 44 indicates a first/last (F/L) mile need. By way of example, the set {fcᵢ:(1≤i≤I)} may comprise at least one or any combination of more than one feature selected from:

fc₁=τ (a time stamp relevant to when features fcᵢ are evaluated for tile j);
fc₂=Δτ (duration of time interval during which features fcᵢ are evaluated);
fc₃=Lc (location of tile center);
fc₄=PTS-d (distance from Lc to a nearest PTS station);
fc₅=nt (where fc₅ represents a set of binary feature that may be used to classify a tile as to neighborhood type, for example, residential, commercial, financial, industrial, rural);
fc₆=ρ (tile population density);
fc₇=IncM (population median income);
fc₈=#Trp-PTS (number of trips to PTS station);
fc₉=Avg-t (average trip time);
fc₁₀=Avg-Cst (average trip cost);
fc₁₁=TripModes (where fc₁₁ represents a set of mobility mode features, each mobility feature in the set giving a fraction of trips to the PTS station given by fcg made using a particular different mode of transportation);
fc₁₂=AVO (fc₁₂ represents a set of mobility mode features that give values for average vehicle occupancy for corresponding modes of transportation given by fc₁₁); and/or
. . . ;
fc_{I}.
It is noted that a set may contain any number of set members and may for example be a null set having no members or a singleton set having only one member.

In a block 208 Moovit-Man determines a first/last mile attention weighting vector AW(F/L, wᵢ)={wᵢ:1≤i≤I) for which weights wᵢ determine a weight given to corresponding features fcᵢ in determining if a given tileⱼ indicates a first/last mile need. For example, population density fc₆ may be heavily weighted by a relatively large value for w₆ and a rural neighborhood in the set of neighborhood type features represented by fc₅ by a low weight w₅ for determining first/last mile need. Optionally, in a block 210 Moovit-Man defines a first/last mile need function NEEDY(F/L, j, fcᵢ, wᵢ) for a given tileⱼ equal to the scalar product SNEF(F/L, j, fcᵢ)·AW(F/L, wᵢ)=Σwᵢfcᵢ. And in a block 212 evaluates NEEDY(F/L, j, fcᵢ, wᵢ) for all tilesⱼ. Optionally, in a block 214, based on NEEDY(F/L, j, fcᵢ, wᵢ), Moovit-Man classifies TILE(j, td, ccⱼ) as indicating or not indicating a first/last mile need F/L. In an embodiment Moovit-Man determines that TILE(j, td, ccⱼ) exhibits a sufficient F/L need that warrants the tile being included in ZOI 40 if the need function NEEDY(F/L, j, fcᵢ, wᵢ) has a value greater than a predetermined value. A value for NEEDY(F/L, j, fcᵢ, wᵢ) may be considered to provide a measure of intensity of the F/L transportation need with, optionally a greater value, for the need function indicative of a greater need.

In a decision block 216, if TILE(j, td, ccⱼ) is classified in block 214 as not indicating a first/last mile need, Moovit-Man may determine in a block 218 that the tile does not belong to first/last mile need ZOI 40 (FIG. 1A). On the other hand if TILE(j, td, ccⱼ) is classified in block 214 as indicating a first/last mile need, Moovit-Man includes TILE(j, td, ccⱼ) in ZOI 40. In a block 222 Moovit-Man optionally determines geofence 42 for ZOI 40 as a polygon that includes the areas of all TILE(j, td, ccⱼ)s determined in block 220 to belong to ZOI 40. It is noted that whereas an area within geofence 42 includes all TILE(j, td, ccⱼ)s determined to belong to ZOI 40 it may also include TILE(j, td, ccⱼ)s that are determined not to be part of ZOI 40. For example, TILE(j, td, ccⱼ)s individualized by labels 51, 52, 53, and 54 that are located within geofence 42 were determined in block 218 not to belong to ZOI 40.

Whereas in procedure 200 a TILE(j, td, ccⱼ) is classified as belonging or not belonging to ZOI 40 based on a function NEEDY(F/L, j, fcᵢ, wᵢ) that is a scalar product SNEF(F/L, j, fcᵢ)·AW(F/L, wᵢ), classifying a TILE(j, td, ccⱼ) as belonging or not belonging to a ZOI is not limited to determining and using a scalar product function such as NEEDY(F/L, j, fcᵢ, wᵢ). For example, a TILE(j, td, ccⱼ) may be classified as belonging to first/last mile ZOI 40 by a neural network that operates on the feature vector SNEF(F/L, j, fcᵢ) for the tile.

In an embodiment Moovit-Man may identify routes that are traveled between locations in ZOI 40 and/or between locations in ZOI 40 and locations of PTS stations in and in the environs of ZOI 40 and use the identified routes to determine relatively heavily traveled traffic corridors between the locations. A traffic corridor, also referred to simply as a corridor, may be a route or bundle of nearby routes that supports or may be used to support a portion of trips between two locations greater than a threshold portion. For example, a route or bundle of nearby routes between a location in a particular tile of ZOI 40 and a location of a particular PTS station 26 or 27 over which a portion of trips between the locations is greater than a given threshold may be determined to be a corridor. A route or bundle of nearby routes between two locations in ZOI 40 or between a PTS station 26 and a PTS station 27 that passes through ZOI 40 may be determined to be a corridor. Routes may be determined to be nearby and suitable for bundling into a channel using any of various suitable temporal or spatial criteria. For example two routes between same locations may be determined to be nearby if a travel time and/or travel distance between the routes is less than a given fraction less than one of a respective travel time and/or distance between the locations. In an embodiment travel routes in a GROI or ZOI may be clustered using a clustering algorithm to identify travel corridors.

In an embodiment Moovit-Man deploys vehicles in a fleet of TOD vehicle to service F/L needs in ZOI 40 responsive to a pattern of corridors that Moovit-Man determines for ZOI 40 and optionally environs.

Whereas FIGS. 1A and 1B exhibit determining ZOIs that are associated with first mile and last mile, F/L, service needs based on geo-tiling, practice of an embodiment of the disclosure is not limited to determining ZOIs based on segmenting a GROI by apriori geo-tiling. For example, in an embodiment Moovit-Man may monitor vehicular traffic to generate a spatiotemporal traffic “activity map” for traffic in GROI 20 independent of predetermined apriori boundaries within the GROI. Moovit-Man may process the map to determine ZOIs and their associated geofences in the GROI that are relevant to different aspects of, optionally F/L, transportation needs.

By way of example, FIG. 1C schematically shows a perspective, planar map of the Roxbury GROI 20 and environs shown in FIG. 1A with an addition shown in FIG. 1C of an overlying schematic vehicular traffic activity map that Moovit-Man may generate for the GROI in accordance with an embodiment of the disclosure. The activity map is labeled to indicate a transportation need for which the activity map is generated and by a pair of clock times that define a period of time for which the activity map is relevant. The activity map shown in FIG. 1C is labeled and referred to by the label F/L(06:00-07:00) and indicates that the map is relevant for F/L traffic activity from 6 AM and 7 AM Boston time in the morning.

Activity map F/L (06:00-07:00) comprises diamond icons 499 that represent locations of trip starts or trip ends in GROI 20 and environs for vehicular trips monitored by Moovit-Man. Each icon 499 represents one or more trip starts and/or trip ends for monitored trips at which the icon is located in the map. A vehicular trip may be a trip undertaken using any type of vehicle. The vehicle may for example, be a private car, taxi, TOD vehicle, a PTS vehicle, e-hike, e-scooter or small dockless car. Traffic activity map F/L(06:00-07:00) schematically shows ZOIs, 501, 502, . . . , 507, and their associated geofence boundaries 501B, 502B, . . . 507B that Moovit-Man determines for F/L transportation needs by processing monitored trips exhibited in GROI 20 and environs between the hours of 6 AM and 7 AM. ZOIs, 501, 502, . . . , 507 may be referred to generically by the number 500 and geofences 501B, 502B, . . . , 507B may be referred to generically by the number 500B. Trip starts and trip ends 499 that are determined by Moovit-Man to be associated with F/L trips and contribute to determining ZOIs 500, are shown shaded. Trip ends and trip starts 499 that are determined not to be associated with F/L trips are unshaded. For example, relatively long distance trips to vacation destinations, or trips associated with relocation of a residence may not be considered F/L trip. Methods for distinguishing trips considered to be F/L trips from trips that are not considered to be F/L trips are discussed below.

FIG. 1D shows a flow diagram 550 of a procedure, also referenced by numeral 550, by which Moovit-Man may generate traffic activity map F/L(06:00-07:00) and identify and delimit ZOIs 500 shown in FIG. 1C that are relevant to F/L transportation needs, in accordance with an embodiment of the disclosure.

In a block 552 of procedure 550 Moovit-Man receives a user request to determine a traffic activity map and consequent ZOIs associated with F/L transportation for the Roxbury neighborhood GROI 20 of the greater Boston area shown in FIG. 1A. In response, in a block 554 Moovit-Man monitors vehicular trips in Roxbury and surrounding area.

Optionally, in a block 556, for each trip in GROI 20 that Moovit-Man monitors, Moovit-Man optionally generates a service need feature vector SNEF(F/L, j, fcᵢ)={fcᵢ:(1≤i≤I)} having features fcᵢ. Features fcᵢ are features that characterize the trip and may be advantageous for classifying the trip as a F/L trip and identifying and characterizing a ZOI in GROI 20 that is relevant for understanding an aspect of F/L needs in GROI 20. In an embodiment the set {fcᵢ:(1≤i≤I)} may comprise at least one or any combination of more than one feature selected from:

fcn₁=ID (assigned ID trip index n);
fcn₂=ti (time stamp);
fcn₃=TripMode (transportation mode: private vehicle, subway, bus, or cab);
fcn₄=TripSt (location of trip start);
fcn₅=TripEn (location of trip end);
fcn₆=TripOcc (transportation mode occupancy for trip n);
fcn₇=TripTime (trip duration);
fcn₈=TripCst (trip cost); and/or
. . . ;
fcn_{I}.

In a block 558 Moovit-Man processes feature vectors of monitored trips to determine whether or not they are F/L trips that may be used for generating a F/L traffic activity map between 6:00 AM and 7:00 AM for GROI 20. Trips may be classified as F/L trips in accordance with any of various suitable criteria. For example, a trip may be classified as an F/L trip if it connects a trip start to or trip end from a PTS station 26 or 27, if the trip duration is between predetermined lower and upper duration bounds, and/or the trip distance is between predetermined lower and upper trip distance bounds. A trip may be classified as an F/L trip by any of various classifiers operating on the SNEF(F/L, j, fcᵢ) feature vector that Moovit-Man determines for the trip.

Optionally, in a block 560 Moovit-Man processes trips that have been determined to be F/L trips to determine locations of clusters of trip starts and/or trip ends. In a block 562 Moovit-Man identifies clusters exhibiting a concentration of trip starts and/or trip ends greater than a threshold concentration as ZOIs 500 relevant to F/L service needs in GROI 20 and environs. Clustering may be performed using any of various clustering algorithms, for example, a nearest neighbor, k-means, or Gaussian mixture model (GMM). In a block 564 Moovit-Man optionally determines respective bounding geofences 501B-507B (generically 500B) for the clusters. Any of various criteria may be used to determine a geofence 500B for a cluster. For example, a bounding geofence for a cluster may be determined as a convex hull of the cluster, or as a density isoline responsive to a density of trip starts and/or trip ends 499 in the cluster, and/or as a spatial derivative isoline responsive to a spatial derivative of the density. For clustering using a GMM soft classification algorithm, a geofence boundary 500B may be determined responsive to respective probabilities of trip starts or trip ends 499 belonging to the cluster provided by the GMM.

Optionally, in a block 566, Moovit-Man pairs trip starts and/or trip ends 499 located in a given ZOI 500 with their respective trip ends and/or trip starts 499 in other of ZOIs 500 to determine highly traveled routes between the given ZOI and the other ZOIs. Highly traveled routes between a same pair of ZOIs may be aggregated, “bundled”, optionally in a block 568 to determine travel corridors between the ZOIs. Travel corridors between different ZOIs 500 are schematically represented by shaded bands 520 that extend between the ZOIs that they connect.

In an embodiment, Moovit-Man operates to continuously monitor traffic in a GROI, such as GROI 20, to generate traffic activity maps for the GROI at different times and determine spatiotemporal geofences that define and bound a time dependent geographic ZOI in the GROI. A given spatiotemporal geofence determined for a GROI is a spatiotemporal envelope that bounds in space and time a region of geography in the GROI considered to be a ZOI relevant to a transportation need which may be time dependent generally in size, shape, and/or possibly location. A cross section of the spatiotemporal geofence at a given time defines a geofence that encompasses an instance of the ZOI that is relevant to the transportation need at the given time, or for a time period including the given time during which the cross section of the spatiotemporal geofence may be considered substantially time invariant. A ZOI determined from a spatiotemporal geofence may have a temporal extent coincident with that of a traffic activity map determined for the spatiotemporal geofence. In an embodiment a period of time over which the spatiotemporal geofence extends is advantageously sufficiently long so that the spatiotemporal geofence can exhibit changes in traffic in the GROI as a function of time that are relevant for planning transportation services responsive to a transportation service need of the GROI. A spatiotemporal geofence may be considered a boundary of a spatiotemporal ZOI.

For example, a spatiotemporal geofence for a GROI may have a temporal extent of about a 24 hour day to exhibit diurnal changes in traffic activity of a GROI relevant for planning daily TOD services provided to the GROI. To provide data advantageous for planning weekly provision of TOD services, a spatiotemporal geofence may extend for a period of a week or several weeks. It is noted that a sampling rate at which Moovit-Man monitors traffic in a GROI may be time dependent. For example, the sampling rate may be greater during periods of time that are expected to exhibit relatively rapid changes in vehicular traffic and relatively smaller during periods of time during which traffic changes are expected to be relatively slow.

FIG. 1E schematically shows a sequence of F/L traffic activity maps for GROI 20 determined by Moovit-Man and spatiotemporal geofences that are defined from data that the activity maps exhibit for a period of time that extends by way of example from about 06:00 to 24:00 in accordance with an embodiment of the disclosure. The activity maps exhibit geofences of ZOIs which Moovit-Man determines for the GROI that are cross sections of the spatiotemporal geofences at different times. The sequence of F/L activity maps shown in FIG. 1E includes activity map F/L(06:00-07:00) shown in FIG. 1C and activity maps F/L(12:00-13:30), F/L(16:00-18:00), and F/L(22:00-24:00). As noted above with respect to activity map F/L(06:00-07:00), the time labels of activity maps in FIG. 1E indicate time periods for which the activity maps are relevant. As indicated by the labels, the traffic activity maps are, optionally, determined for different duration time periods. The time period duration of a given activity map may for example be determined responsive to rates of change in traffic activity in GROI 20 that may be expected to occur between the different times that label the given activity map. ZOIs in different traffic activity maps that are associated with substantially a same geographic location and belong to a same spatiotemporal geofence are labeled by a same numeric prefix followed by a time stamp in parenthesis that distinguishes each of the ZOIs and indicates a time of the traffic activity map to which the ZOI belongs. In FIG. 1E the time stamp of a given ZOI is the same as the first time labeling the traffic activity map in FIG. 1E that includes the given ZOI.

Geofences of ZOIs that belong to same spatiotemporal geofence are cross sections of the spatiotemporal geofence and are connected by contour lines labeled by the letters “ST” followed by the common prefix labeling the ZOIs that belong to the spatiotemporal geofence. The contour lines of a spatiotemporal geofence indicate a contour and general shape in time and space of the spatiotemporal geofence. A given spatiotemporal geofence may be referred to by the label labeling its contour lines. Three spatiotemporal geofences in accordance with an embodiment are explicitly designated by contour lines in FIG. 1E. Contour lines ST501, ST506 and ST507 are explicitly shown and outline the shape of spatiotemporal geofences ST501, ST506 and ST507 to which ZOIs sharing the numeral prefixes 501, 506, and 507 respectively belong.

As schematically indicated in FIG. 1E spatiotemporal geofences have spatiotemporal shapes that are determined by the geographical shapes and time dependence of the ZOIs that they respectively envelope. Different spatiotemporal geofences may, and generally will, have different spatiotemporal shapes to reflect the different patterns of traffic activity that characterize their respective ZOIs. For example, spatiotemporal geofence ST507 has a temporal extent from 06:00 to 18:00 because F/L relevant traffic activity for ZOI 507 begins at about 06:00 and is absent after about 18:00. On the other hand spatiotemporal geofences ST501 and ST506 are F/L “traffic active” and have temporal extent from about 06:00 to about 24:00. Spatiotemporal geofence ST501 is also characterized by a relatively large spatiotemporal volume compared to the other spatiotemporal geofences. The large volume of ST501 reflects the relatively large and F/L traffic intensive ZOI 501. ST501 also exhibits a relatively large decrease in F/L traffic activity in the morning hours between about 09:30 and 11:00 as indicated by a substantial narrowing of the cross section of ST501 between activity maps F/L(06:00-07:00) and F/L(12:00-13:30). The narrowing may reflect settling of traffic activity after commuter traffic to work has subsided. The relatively constant cross section of ST501 between the afternoon hour of about 13:30 and the early evening hour of about 18:00 may be reflective of a mix of errand running commercial traffic and homegoing commuter traffic.

In an embodiment Moovit-Man may acquire data for trips associated with traffic in a GROI that provide information sufficient to distinguish different types of trips that the traffic comprises and/or to provide a profile of a population generating the traffic. The identification of different trip types and/or a population profile may be used to understand the temporal and spatial changes, such as those noted above, that characterize a spatiotemporal geofence associated with the GROI and to improve adaptation of a TOD service to spatiotemporal traffic needs of the GROI.

The type of a trip may characterize a feature of the trip, purpose and/or circumstance for which the trip is undertaken or engaged in. For example, a trip may be classified responsive to a trip travel distance and/or typical duration, features of the location or characteristic of the trip start and or trip end a terrain over which the trip is taken or population density along a route of the trip. A trip may be classified as commuter trip, a tourist sightseeing trip, a shopping trip, or a trip to a mass event such as to a football game. A profile of a population generating traffic in a GROI may for example provide an age, occupation, or income distribution for the population. Moovit-Man may generate SNEF vectors for trips associated with the GROI comprising SNEF vector feature components fcnᵢ that may be used to indicate the types of the trips and/or to provide population profile data. Moovit-Man may use the type and/or profile SNEF vector components to segment the data and provide traffic activity maps and associated spatiotemporal geofences for a particular segment or segments of the traffic in the GROI.

In an embodiment one or more graph convolutional networks may be used to process traffic activity maps, such as the F/L traffic activity maps shown in FIG. 1E, to determine ZOIs and spatiotemporal geofences for a GROI and/or to predict traffic activity for the GROI.

In an embodiment, Moovit-Man operates to deploy TOD vehicles in a GROI and/or a ZOI based on spatial and/or temporal features of a spatiotemporal geofence associated with the GROI and/or ZOI. For example, Moovit-Man may deploy TOD vehicles to a GROI based on a feature or features of the GROI, such as a number spatiotemporal geofences identified in the GROI, corridors connecting the spatiotemporal geofences, traffic density that the corridors exhibit, corridor carrying capacities, and/or respective temporal development of the feature or features. Moovit-Man may determine a number of TOD vehicles deployed to a particular ZOI for a particular time period responsive to a spatial extent of the ZOI, density, and/or total number of trip-ends and/or trip starts located in the ZOI during the particular time period. Deployment of TOD services may be determined based on the type of traffic in the GROI, and/or profile of a population generating the traffic.

In an embodiment Moovit-Man may process SNEF vectors associated with trips in a given ZOI to determine clusters of SNEF vectors and deploy a number of TOD dedicated to providing service only for trips in the given ZOI that are classified as being associated with SNEF vectors that are clustered in a particular cluster. For example Moovit-Man may determine to deploy a particular number of TOD vehicles for a given time period during the day dedicated to servicing only business trips between two particular locations in the ZOI during the given time period. It is noted that deploying a number of TOD vehicles dedicated to servicing trips “belonging to” a particular cluster of SNEF vectors in the given ZOI simplifies the decision process and time required for assigning TOD vehicles to trips in ZOI.

In an embodiment Moovit-Man may process SNEF vectors associated with trips in a given ZOI to determine clusters of SNEF vectors and deploy a number of TOD dedicated to providing service only for trips in the given ZOI that are classified as being associated with SNEF vectors that are clustered in a particular cluster. For example Moovit-Man may determine to deploy a particular number of TOD vehicles for a given time period during the day dedicated to servicing only business trips between two particular locations in the ZOI during the given time period. Deploying a number of TOD vehicles dedicated to servicing trips “belonging to” a particular cluster of SNEF vectors in the given ZOI simplifies the decision process and time required for assigning TOD vehicles to trips in ZOI.

In an embodiment, Moovit-Man may process SNEF vectors associated with a given spatiotemporal geofence, for example ST501, ST502, . . . ST507 of GROI 20, to generate a time dependent TOD-Deployment vector to determine a number of TOD vehicles to assign to the spatiotemporal geofence and a GROI to which the spatiotemporal geofence belongs. If an m-th (1≤m≤M) spatiotemporal geofence in a GROI is referenced by an alphanumeric label STm, a time dependent TOD-Deployment vector for the spatiotemporal geofence for a time period of duration Δt at time t may be written TOD-Dep(STm, Δt, t, dfcₖ)={dfc(t, Δt)_{m,k}:(1≤k≤K} where the features dfc(t, Δt)ₖ are time dependent feature components relevant for determining a number of TOD vehicle to be deployed to the spatiotemporal geofence STm. In an embodiment the set {dfc(t, Δt)_{m,k}:(1≤k≤K)} for the m-th spatiotemporal geofence may comprise by way of example at least one or any combination of more than one feature selected from:
dfc(t, Δt)_{m,1}=N-TripSt(t, Δt) (a number of trip starts in the ZOI (i.e. the spatial cross section) of the m-th spatiotemporal geofence at time t for the time period of duration Δt);
dfc(t, Δt)_{m,2}=N-TripEn(t, Δt) (a number of trip ends in the ZOI for time t and Δt);
dfc(t, Δt)_{m,3}=B-TripSt(t, Δt) (number of trip starts of the N-TripSt that are business commuter trip starts);
dfc(t, Δt)_{m,4}=T-TripSt(t, Δt) (number of tourist trip starts of the N-TripSt);
dfc(t, Δt)_{m,5}=S-TripSt(t, Δt) (number of shopping trip starts of the N-TripSt);
dfc(t, Δt)_{m,6}=ME-TripSt(t, Δt) (number of mass event trip starts of the N-TripSt);
dfc(t, Δt)_{m,7}=P≤40-TripSt(t, Δt) (number of trip starts of the N-TripSt for people younger than 40);
dfc(t, Δt)_{m,8}=40<P≤60-TripSt(t, Δt) (number of trip starts of the N-TripSt for people between 40 & 60);
dfc(t, Δt)_{m,9}=60≤P≤80-TripSt(t, Δt) (number of trip starts of the N-TripSt for people between 60 & 80); and/or
. . . ;
dfc(t, Δt)_{m,K.}

Optionally Moovit-Man determines a weighting vector DEPW(w_{m,k}) comprising a weighting factor w_{m,k} for each dfc(t, Δt)_{m,k}. Moovit-Man may determine a number of TOD vehicles to be deployed to spatiotemporal ZOI bounded by a spatiotemporal geofence STm for a period of time Δt at a time t responsive to a scalar product TOD-Dep(STm, Δt, t, dfcₖ)·DEPW(w_{m,k}) of the weighting vector and the deployment vector TOD-Dep(STm, Δt, t, dfcₖ). Weights in weighting vector DEPW(w_{m,k}) may be determined to reflect any of various motives for providing a TOD service and/or how well the motives are served by the service. For example, the weighting vector may be configured to stimulate use of a TOD service by a particular segment of the population of users, encourage use of a particular type of TOD service such as short distance or long distance trip TOD service, improve quality of service between particular spatiotemporal geofences, or decrease road congestion between attraction and production (A&P) hubs.

By way of example of relative weighting that weighting vector DEPW(w_{m,k}) may apply to components of a deployment vector TOD-Dep(STm, Δt, t, dfcₖ), the weighting vector may weight the number of business commuter type trip starts dfc(t, Δt)_{m,3} greater than the number of tourist trip starts dfc(t, Δt)_{m,4} which in turn may be weighted greater than the weighting for shopping trip starts dfc(t, Δt)_{m,5}. The relative weighting may reflect the relative sensitivities of a population to trip delays of business, tourist and shopping trips. The relative weights may be geared to distributing traffic between A&P hubs over increased or different periods of time.

In an embodiment the relative weighting may be configured to restrict services that a TOD vehicle provides to transportation needs associated with a particular ZOI or a traffic feature of the ZOI. For example, the weighting vector may restrict deployment of a TOD vehicle to provide transportation only for trips that have a trip start or trip end in the particular ZOI or only to people that are domiciled in the ZOI or have a place of work or study in the particular ZOI. Such a configuration of the relative weighting effectively dedicates the TOD to the given ZOI and may be advantageous in improving a QoS feature, such as response time or compute resource required to assign the TOD to a particular trip that the TOD vehicle provides. It is noted that different TOD vehicles belonging to a same fleet of TOD vehicles or assigned to a same GROI or ZOI may be associated with different weighting vectors DEPW(w_{m,k}).

In an embodiment Moovit-Man may assign portions of a total number of TOD vehicles deployed to a given spatiotemporal geofence at time t to each corridor that is “connected to” the given spatiotemporal geofence in proportion to a number of trip starts in the spatiotemporal geofence associated with trips “through the corridor”.

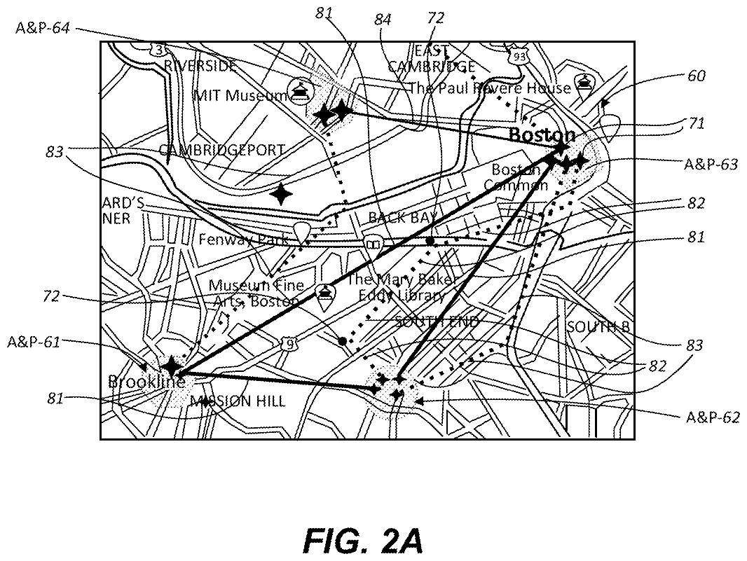

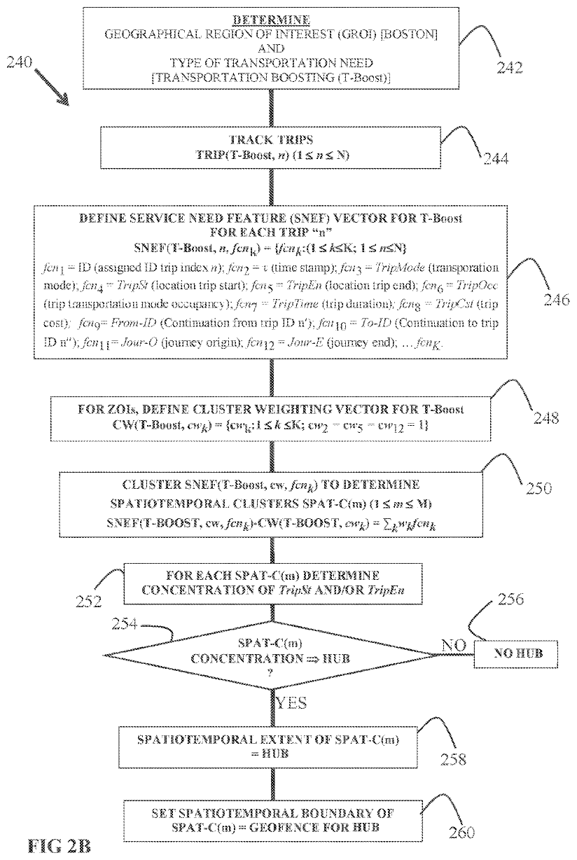

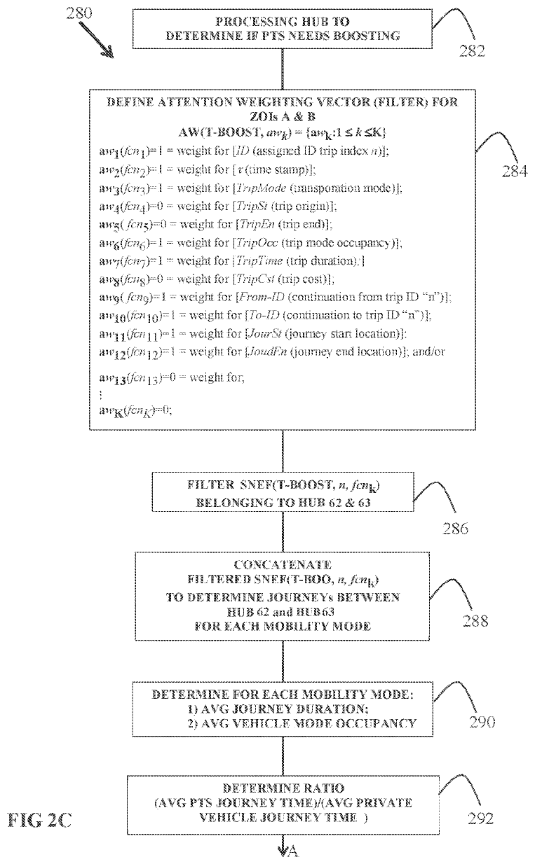

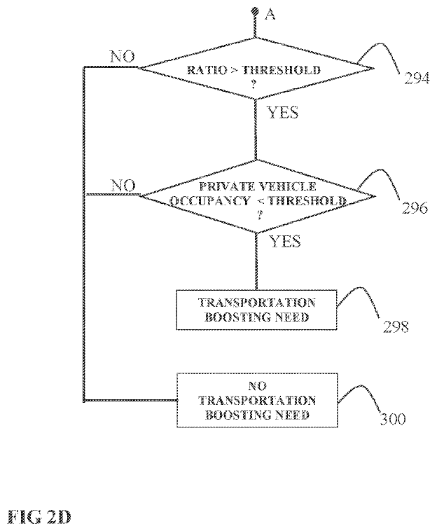

FIG. 2A schematically shows a map of a GROI 60 that is a portion of the greater Boston area for which, Moovit-Man identifies a plurality of ZOIs that are attraction and production (A&P) transportation hubs characterized by a concentration of incoming and outgoing traffic. As discussed below Moovit-Man operates to determine whether the incoming and outcoming traffic indicates that PTS services available to the identified A&P hubs are inadequate and in need of augmentation, optionally referred to as “boosting”, by additional transportation resources.

In FIG. 2A A&P transportation hubs, also referred to as transportation hubs, A&P hubs, or simply hubs, identified by Moovit-Man in accordance with an embodiment are indicated by stippled regions A&P-61, A&P-62, A&P-63, and A&P-64. Various modes of transportation that service trips and journeys between hubs A&P-61, A&P-62, A&P-63, and A&P-64 and respective routes travelled by the modes of transportation are indicated by different stylized lines. Locations at which a journey starts or ends are indicated by four-pointed star icons 71, and intermediate stops, also referred to as waystations, along a journey travel route between journey start and end locations are indicated by solid circles 72.

A journey is a travel instance undertaken between a first location, a journey start location, at which a person initiates traveling to reach a “final” desired destination at a second location, a journey end location, at which the desired destination is located. A journey may comprise a plurality of trips which are portions of the journey between two locations, one of which locations is a waystation, along the journey route. A waystation is a location at which a person making a journey pauses traveling, for example to change modes of travel, freshen up, or meet a traveling companion. A journey comprising a single trip is a “degenerate journey” and may be referred to as a trip as well as a journey. Stylized lines, 81, 82, 83, and 84 in FIG. 2A represent travel by private vehicle, subway, bus, and cab, respectively. An individual stylized line, 81, 82, 83, and 84 indicates a general direction of travel substantially “as the crow flies” and not the actual street routes, which may appear quite different from the crow flies trajectory, of a plurality of trips or journeys made using the mode of transportation that the stylized line represents.

FIG. 2B shows a flow diagram 240 of a procedure, also referenced by numeral 240, by which Moovit-Man may identify and delimit attraction and production transportation hubs A&P-61, A&P-62, A&P-63, and A&P-64 shown in FIG. 2A, in accordance with an embodiment of the disclosure. FIGS. 2C and 2D show a flow diagram 280 of a procedure, also referenced by numeral 280, by which Moovit-Man may determine whether traffic to and from hubs A&P-61, A&P-62, A&P-63, and A&P-64 indicate transportation boosting needs, in accordance with an embodiment of the disclosure.

With reference to procedure 240 shown in FIG. 2B, in a block 242 Moovit-Man receives a request to identify and locate transportation hubs in the greater Boston area and determine whether traffic to and/or from the hubs indicate a need to boost transportation resources available to travel to and from the hubs. In response, optionally in a block 244 Moovit-Man operates to acquire data for a plurality of N trips TRIP(T-Boost, n) 1≤n≤N that are traveled in the greater Boston area for analysis to locate traffic hubs and determine a transportation “booster need” for the area, in accordance with an embodiment. Optionally in a block 246 Moovit-Man defines a SNEF feature vector SNEF(T-Boost, n, fcnₖ) having K components fcnₖ, 1≤k≤K that may be processed to identify traffic A&P hubs and determine transportation booster (T-Boost) needs for the A&P hubs. By way of example, a set {fcnₖ: 1≤k≤K} may include at least one or any combination of more than one feature selected from:

fcn₁=ID (assigned ID trip index n);
fcn₂=r (time stamp);
fcn₃=TripMode (transportation mode: private vehicle, subway, bus, or cab);
fcn₄=TripSt (location trip start);
fcn₅=TripEn (location trip end);
fcn₆=TripOcc (trip transportation mode occupancy);
fcn₈=TripTime (trip duration);
fcn₈=TripCst (trip cost);
fcn₉=From-ID (continuation from trip ID “n”);
fcn₁₀=To-ID (continuation to trip ID “n”);
fcn₁₁=JourSt (journey start location);
fcn₁₂=JoudEn (journey end location); and/or
. . .
fcn_{K}.

Optionally in a block 248 Moovit-Man defines a cluster weighting vector CW(T-Boost, cwₖ)={cwₖ:1≤k≤K}. For CW(T-Boost, cwₖ), optionally cwt=cw₄=cw₅=cw₁2=1 may be used to weight features in feature vectors SNEF(T-Boost, n, fcnₖ) for processing to cluster the feature vectors and identify transportation hubs in the greater Boston area. Optionally in a block 250, Moovit-Man generates a weighted feature vector for each trip TRIP(T-Boost, n) by multiplying, element by element, components in SNEF(T-Boost, n, fcnₖ) by components in CW(T-Boost, cwₖ). In the block Moovit-Man may cluster the weighted feature vectors to determine spatiotemporal clusters SPAT-C(m) 1≤m≤M of trip start locations, fcn₄=TripSt, and/or trip end locations, fcn₅=TripEn.

In a block 252 Moovit-Man may determine a concentration of trip start locations (TripSt) and/or trip end locations (TripEn) and in a decision block 254 determines whether or not the concentration of trip start and/or end locations for a cluster SPAT-C(m) indicates that the cluster is a A&P transportation hub. By way of example, a concentration of clustered trip start and/or end locations may indicate a hub if the concentration is greater than a predetermined threshold concentration. Alternatively, features of a cluster SPAT-C(m), such as a centroid, spatial spread, and/or a point cloud of trip start and end locations may be input to a neural network for processing to determine if the cluster warrants being considered a A&P hub. If a hub is not indicated, optionally in a block 256 the SPAT-C(m) is not considered to be a A&P hub. On the other hand, if the concentration does indicate a hub, optionally in a block 258 the spatiotemporal cluster SPAT-C(m) is considered to be a A&P hub. In a block 260, Moovit-Man may determine a spatiotemporal geofence for the SPAT-C(m) and thereby the A&P hub. Determining for the spatiotemporal geofence a geofence at a given time or time period may comprise determining a convex polygon for the trip start and/or end locations in the cluster for the given time.

With reference to procedure 280 shown in FIGS. 2C and 2D, Moovit-Man operates to determine if an A&P 61, 62, 63, or 64 identified by procedure 240 shown in FIG. 2B exhibits a particular transportation need. In a block 282 Moovit-Man is directed to determine if a QoS provided by the PTS service of buses and subways in the Boston area shown in FIG. 2A is unsatisfactory and in need of boosting.

In a block 284 Moovit-Man may define an attention weighting vector AW(T-Boost, awₖ)={awₖ:1≤k≤K} for weighting components of SNEF(T-Boost, n, fcnₖ), optionally determined by procedure 240, to determine if trips TRIP(T-Boost, n) associated with identified A&Ps 61, 62, 63, and/or 64 indicate a transportation boosting deficiency. By way of example, weighting components, awₖ, of AW(T-Boost, awₖ) for weighting corresponding components fcnₖ of SNEF(T-Boost, n, fcnₖ) may be assigned values:

aw₁(fcn₁)=1=weight for [ID (assigned ID trip index n)];
aw₂(fcn₂)=1=weight for [τ (time stamp)];
aw₃(fcn₃)=1=weight for [TripMode (transportation mode)];
aw₄(fcn₄)=0=weight for [TripSt (trip origin)];
aw₅(fcn₅)=0=weight for [TripEn (trip end)];
aw₆(fcn₆)=1=weight for [TripOcc (trip mode occupancy)];
aw₇(fcn₇)=1=weight for [TripTime (trip duration);]
aw₈(fcn₈)=0=weight for [TripCst (trip cost)];
aw₉(fcn₉)=1=weight for [From-ID (continuation from trip ID “n”)];
w₁₀(fcn₁₀)=1=weight for [To-ID (continuation to trip ID “n”)];
aw₁₁(fcn₁₁)=1=weight for [JourSt (journey start location)];
aw₁₂(fcn₁₂)=1=weight for [JoudEn (journey end location)]; and/or
aw₁₃(fcn₁₃)=0=weight for;

[symbol]

aw_{K}(fcn_{K})=0;

It is noted that weights aw₄(fcn₄) for TripSt (trip origin)], aw₅(fcn₅) for TripEn (trip end), and aw₈(fcn₈) for TripCst (trip cost)] are, by way of example, set to zero. TripSt and TripEn, and TripCst may not be pertinent for a particular trip if values fcn₉ for From-ID, fcn₁₀ for To-ID, fcn₁₁ for JourSt, and fcn₂ for JourEn, which are weighted “1” in AW(T-Boost, awₖ) are known. And fcng for TripCst (trip cost), while relevant for many different types of analysis of transportation needs may not be relevant for determining a boosting need.

In a block 286 Moovit-Man may filter SNEF(T-Boost, n, fcnₖ) to select for analysis data optionally related to TRIP(T-Boost, n)s, having a JourSt (journey start location) in A&P 62 and a JourEn (journey end location) in A&P 63 or a JourEn in A&P 62 and a JourSt in A&P 63. In a block 288 Moovit-Man uses values from selected SNEF(T-Boost, n, fcnₖ) vectors for ID trip indices n from components fcn₁, time stamps τ from components fcn₂, TripModes from fcn₂, from From-IDs from fcn₉, and To-IDs from fcn₁₀ to concatenate trips to provide transportation data for complete journeys between A&P 62 and A&P 63. It is noted that a complete journey determined in block 288 may have been made using only a single mode of transportation or a mix of different modes of transportation.

Optionally in a block 290 Moovit-Man determines for each single mode and for mixed mode journeys between A&P 62 and A&P 63: 1) an average journey duration; and 2) an average vehicle occupancy. And in a block 292 Moovit-Man may determine a ratio between an average journey time for journeys between A&P 62 and A&P 63 made at least in part by a PTS vehicle divided by an average journey time for travel between A&P 62 and A&P 63 by private vehicle.

In a decision block 294, if the ratio determined in block 292 is less than a predetermined threshold Moovit-Man optionally proceeds to a block 300 and determines that PTS traffic between A&P 62 and A&P 63 does not exhibit a transportation boosting need. On the other hand, if in block 294 the ratio is greater than the predetermined threshold, Moovit-Man proceeds to a block 296 to determine whether vehicle occupancy for journeys between A&P 62 and A&P 63 made by private vehicles is less that a predetermined occupancy threshold. If the occupancy is not less than the predetermined occupancy threshold Moovit-Man proceeds to block 300 and determines that traffic between A&P 62 and A&P 63 does not exhibit a transportation boosting need. On the other hand, if in block 296 private vehicle occupancy is less than the occupancy threshold Moovit-Man may determine that traffic between A&P 62 and A&P 63 does exhibit a transportation boosting need.

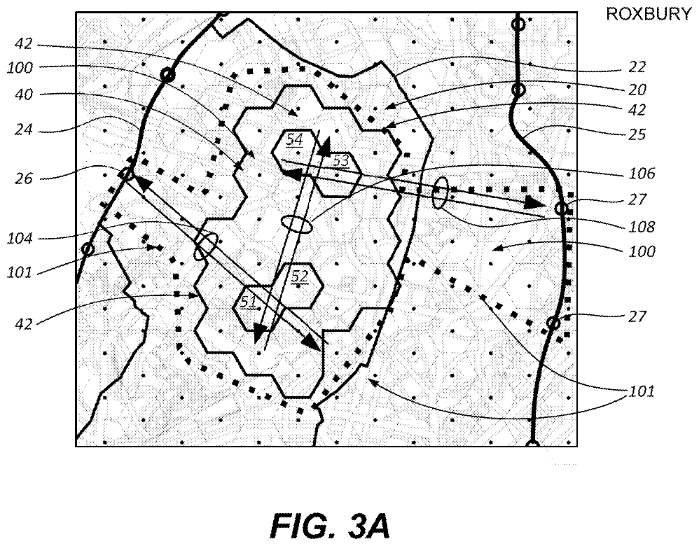

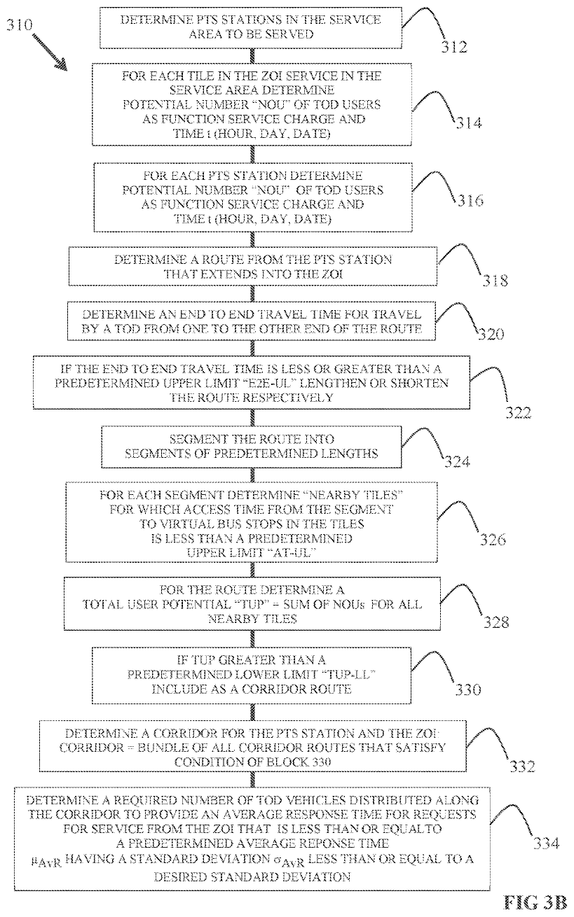

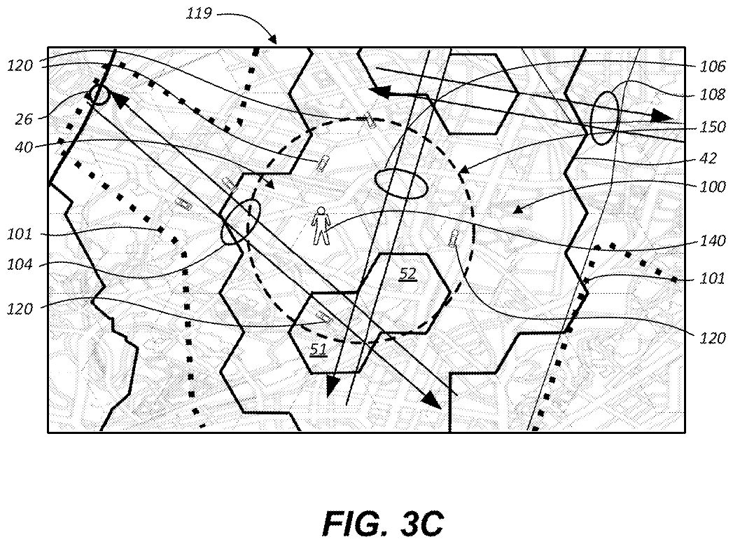

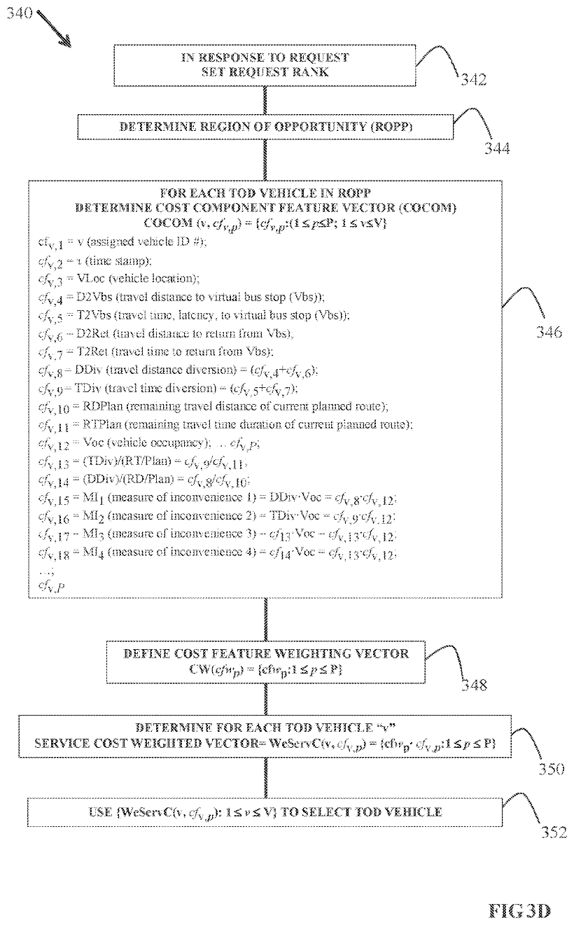

FIG. 3A schematically shows a service area 100 delimited by a service area boundary 101 established for providing TOD services to the first/last mile ZOI 40 shown in FIG. 1A, in accordance with an embodiment of the disclosure. TOD service area 100 includes ZOI 40 bounded by boundary 42 and optionally extends to include a PTS station 26 of PTS line 24 and two PTS stations 27 of PTS line 25. By way of example, service area 100 includes three TOD travel corridors 104, 106, and 108, schematically represented by oppositely directed arrows bundled by an ellipse. TOD vehicles deployed in service area 100 may travel back and forth along roadways in and along corridors 104 and 108 to provide first/last mile service to users in ZOI 40 for travel to and from PTS stations 26 and 27 in service area 100. TOD vehicles deployed in service area 100 may travel back and forth along roadways along corridor 106, which may also be referred to as an internal corridor, to provide first/last mile service to users in ZOI 40 for travel within ZOI 40 along major thoroughfares of the ZOI. In accordance with an embodiment travel corridors 104, 106, and 108, are configured to include and provide access to main thoroughfares that support relatively efficient, unobstructed movement of TOD vehicles and to be relatively close to concentrations of populations in ZOI 40 that use TOD services. By way of example Moovit-Man may determine corridors 104 or 108, which because the extend beyond ZOI 40 may be referred to as external corridors, for service area 100 and ZOI 40, in accordance with a procedure 310 shown in FIG. 3B.

In a block 312 of procedure 310 Moovit-Man may determine PTS stations for a service area to be served. In a block 314 for each tile in the ZOI service area Moovit-Man optionally determines a potential number “NOU” of TOD users as function a service charge and time t (hour, day, date). Optionally in a block 316 for each PTS station Moovit-Man optionally determines a potential number NOU of TOD users as function service charge and time t (hour, day, date). In an embodiment, in a block 318 Moovit-Man determines a route from the PTS station that extends into the ZOI and in a block 320 may determine an end to end travel time for travel by a TOD from one to the other end of the route. In a block 322 if the end to end travel time is less or greater than a predetermined upper limit “E2E-UL” Moovit-Man may respectively lengthen or shorten the route and in a block 324 segments the route into segments of optionally predetermined lengths.

Optionally in a block 326 Moovit-Man determines for each segment “nearby tiles” for which access time from the segment to virtual stops in the tiles is less than a predetermined upper limit “AT-UL” and proceeds to a block 328 to determine for the route a total user potential “TUP” equal to a sum of NOUs for all tiles determined to be “nearby”. In a block 330 if TUP greater than a predetermined lower limit “TUP-LL” the route is included as a corridor route. In an embodiment Moovit-Man determines a corridor for the PTS station and the ZOI that is optionally a bundle of all corridor routes for which the TUP is determined in block 330 to be a corridor route.

In a block 334 Moovit-Man optionally determines a number of TOD vehicles to be distributed along the corridor so that an average response time μ_{AvR} for requests for service from the ZOI is less than or equal to a predetermined advantageous average response time having a standard deviation σ_{AvR} less than or equal to a desired standard deviation.

Internal corridor 106 may be determined based on at least one attraction production A&P hub internal to ZOI 40, heavily traveled thoroughfares in the ZOI, and/or or to provide connection to external corridors 104 and 108 using a procedure similar to that used to determine external corridors 104 and 108.

It is noted that in accordance with an embodiment of the disclosure the potential number of users, NOUs, of TOD services in a ZOI tile is time dependent. As a result, Moovit-Man may dynamically determine a number and geometry of corridors in a service area of a given ZOI, or quantities or distributions of TOD vehicles along the corridors as functions of time. Optionally, Moovit-Man processes time resolved historic data characterizing NOUs to determine functions representing the NOUs in a ZOI as a function of time. In an embodiment Moovit-Man uses the functions to anticipate changes in demand for TOD services in the ZOI, and in response to an anticipated change may adjust at least one or any combination of more than one of a number of corridors determined for the ZOI, their respective geometries, or quantities or distributions of TOD vehicles associated with the corridors.

In accordance with an embodiment Moovit-Man uses a tempest map and an associated allocation algorithm to allocate TOD vehicles from a fleet of TOD vehicles 120 deployed to service users in ZOI 40. A tempest map optionally comprises for each TOD vehicle in the TOD fleet a substantially real time location of the vehicle, passenger occupancy, a current route that the TOD vehicle is intended to travel and associated virtual stops at which the vehicle has been committed to stop to let off or take on passengers. By way of example, FIG. 3C schematically shows a tempest map 119 showing an enlarged portion of service arca 100 shown in FIG. 3A and TOD vehicles 120 in the service area that are tracked by the tempest map, in accordance with an embodiment of the disclosure. A user at a virtual stop near the Washington Park area in ZOI 40 has requested that Moovit-Man provide a TOD vehicle 120 to take the user to PTS station 26 (FIG. 3A).

In response to user 140's request Moovit-Man operates to allocate a TOD vehicle 120 to take user 140 to PTS station 26 (FIG. 3A), optionally in accordance with an allocation procedure illustrated in a flow diagram 340 shown in FIG. 3D.

In a block 342 of allocation procedure 340 Moovit-Man optionally ranks user 140 as to whether or not the user is located in ZOI 40, and if the user is not within ZOI 40 ignores the request. It is noted that ZOI 40 does not include areas indicated by tiles 51, 52, 53, and 54. In a block 344 Moovit-Man may determine an, optionally circular, region of opportunity (ROPP) indicated by a circular dashed boundary 150 shown in FIG. 3B. In accordance with an embodiment of the disclosure Moovit-Man considers only TOD vehicles located within ROPP 150 as candidates for a TOD vehicle 120 to pick up user 140, and in a block 346 determines for each TOD vehicle in ROPP 150 a feature vector having cost components cfₚ (1≤p≤P) that may be used to determine a cost for the TOD vehicle 120 to service the user 140 request. Assuming that there are, “V”, TOD vehicles in ROPP 150, a cost component feature vector for a v-th TOD vehicle may be written, COCOM(v, cf_{p,v})={cf_{p,v}:(1≤p≤P)}, where (1≤v≤V).

In an embodiment the set of COCOM(v, cf_{p,v}) cost components {cf_{v,p}:(1≤p≤P)} may comprise the following components:

cf_{v,1}=v (assigned vehicle ID #);
cf_{v,2}=τ (time stamp);
cf_{v,3}=VLoc (vehicle location);
cf_{v,4}=D2Vbs (travel distance to virtual stop (Vbs));
cf_{v,5}=T2Vbs (travel time, latency, to virtual stop (Vbs));
cf_{v,6}=D2Ret (travel distance to return from Vbs);
cf_{v,7}=T2Ret (travel time to return from Vbs);
cf_{v,8}=DDiv (travel distance diversion)=(cf_{v,4}+cf_{v,6});
cf_{v,9}=TDiv (travel time diversion)=(cf_{v,5}+cf_{v,7});
a_{v,10}=RDPlan (remaining travel distance of current planned route);
cf_{v,11}=RTPlan (remaining travel time duration of current planned route);
cf_{v,12}=VoC (vehicle occupancy);
cf_{v,13}=(TDiv)/(RT/Plan)=cf_{v,9}/cf_{v,11};
cf_{v,14}=(DDiv)/(RD/Plan)=cf_{v,8}/cf_{v,10};
cf_{v,15}=MI₁ (measure of inconvenience 1)=DDiv·VoC=cf_{v,8}·cf_{v,12};
cf_{v,16}=MI₂ (measure of inconvenience 2)=TDiv·VoC=cf_{v,9}·cf_{v,12};
cf_{v,17}=MI₃ (measure of inconvenience 3)=cf₁₃·VoC=cf_{v,13}·cf_{v,12};
cf_{v,18}=MI₄ (measure of inconvenience 4)=cf₁₄·VoC=cf_{v,13}·cf_{v,12}; [symbol]
;
cf_{v,P}.

Optionally, in block 348 Moovit-Man defines a cost feature weighting vector, CW(cfwₚ)={cfwₚ:1≤p≤P}, and in a block 350 optionally determines a service cost weighted vector WeServC(v, cf_{v,p}, cfwₚ) for each TOD vehicle “v”, where WeServC(v, cf_{v,p}, cfwₚ)={cf_{v,p}·cfwₚ:1≤p≤P}. In a block 352 Moovit-Man uses the cost vectors WeServC(v, cf_{v,p}, cfwₚ) to select a TOD vehicle to pick up user 140 and bring the user to PTS station 26.

In using WeServC(v, cf_{v,p}, cfwₚ) to determine allocation of a vehicle for user 140 Moovit-Man may assign relatively large weight factors cfwₚ to measures of inconvenience such as at least one or any combination of more than one of MI₁, MI₂, MI₃, and/or MI₄. The MI components are sensitive to a number of passengers inconvenienced by a deviation from a given TOD route plan and indicate an amplified cost if a relatively large number of TOD riders suffer a given inconvenience caused by the deviation. As a result, empty TOD vehicles in ROPP 150 may be favored over occupied TOD vehicles in the ROPP for assignment to user 140. It is noted that whereas FIG. 3B shows and the above discussion refers to a single ROPP 150, practice of embodiments of the disclosure are not limited to a single ROPP to select a TOD to service a given client request. For example, Moovit-Man may define different size ROPPs of different sizes and or distances from a given virtual stop to assign as functions of vehicle occupancies VoC. For example for TOD vehicles occupied by smaller numbers of riders, Moovit-Man may define ROPPs that are larger than and/or farther from a given virtual stop than ROPPs for vehicles occupied by larger number of riders.

Using the cost vectors WeServC may comprise determining a scalar product CW(cfwₚ)·COCOM(v, cf_{p,v}) and selecting a TOD vehicle having a smallest scalar product to service user 140. Optionally, a neural network may be used to process vectors COCOM(v, cf_{p,v}) and/or WeServC(v, cf_{v,p}, cfwₚ) to select a TOD vehicle to serve the user.

There is therefore provided in accordance with an embodiment of the disclosure with a method for deploying a fleet of transportation on demand (TOD) vehicles for a geographical region of interest (GROI), the method comprising: monitoring trips in the GROI; determining a traffic activity map for the GROI for each of a plurality of different times; processing the traffic activity maps to identify time dependent zones of interest (ZOIs) in the GROI that exhibit a given transportation need; determining traffic corridors that support or may be used to support trips between the identified ZOIs; determining spatiotemporal geofences responsive to the time dependent ZOIs; and deploying TOD vehicles based on the spatiotemporal geofences; wherein deploying TOD vehicles in the GROI comprises deploying TOD vehicles responsive to spatiotemporal shapes of the spatiotemporal geofences. Optionally deploying TOD vehicles in the GROI comprises deploying TOD vehicles responsive to a number of the spatiotemporal geofences determined for the GROI. Alternatively or additionally, deploying TOD vehicles in the GROI may comprise deploying TOD vehicles responsive to a number of traffic corridors connecting the spatiotemporal geofences.

In an embodiment the method comprises deploying TODs to a given spatiotemporal geofence for a given time period responsive to at least one feature characterizing the spatiotemporal geofence for the given time period. Optionally, the at least one feature comprises a size of a geographic area of the GROI delimited by a geofence of the spatiotemporal geofence at the given time. Alternatively or additionally, the at least one feature may comprise a number of trips starts and/or trip ends located within the geofence during the given time period.

In an embodiment the at least one feature comprises a time derivative of a number of trips starts and/or trip ends located within the geofence during the given time period.

In an embodiment determining the traffic activity map comprises classifying each of the monitored trips according to a type of trip from among a plurality of trip types. Optionally, the plurality of trip types comprises at least one or any combination of more than one of a: commuter trip; connecting trip; sightseeing trip; shopping trip; or trip to a scheduled event. Alternatively or additionally, deploying TOD vehicles comprises deploying TOD vehicles responsive to a number of monitored trips classified to each of the plurality of trip types. Optionally, deploying TOD vehicles responsive to a number of monitored trips comprises providing a weighting vector that associates a weight for each trip type and deploying TOD vehicles responsive to a number of trips classified to each trip type multiplied by the weight associated with the trip. In an embodiment the method comprises determining a distribution of trip types based on the classification of trip types and deploying a TOD vehicle responsive to the distribution.

In an embodiment determining the traffic activity map comprises determining at least one population profile characterizing a population generating the monitored trips by a distribution of values for at least one profile parameter. Optionally, the at least one population profile comprises at least one or any combination of more than one of an age profile, occupation profile, income profile. Alternatively or additionally, the at least one profile parameter comprises at least one or any combination of more than one of age, occupation, income, location of residency. In an embodiment deploying TOD vehicles comprises deploying the vehicles responsive to the distribution of values for the at least one profile parameter. Optionally, deploying responsive to the distribution of values for the at least one profile comprises weighting values of the distribution and deploying TOD vehicles responsive to the weighted values.

In an embodiment the plurality of different times span a period of at least a day.

There is further provided in accordance with an embodiment of the disclosure a method of anticipating a demand for transportation on demand (TOD) vehicles operating to service users in a geographical region of interest (GROI), the method comprising: defining at least one transportation need that is serviceable by TOD vehicles; determining components that characterize transportation in the GROI as a function of time and spatial location and are useable to provide a measure of the transportation need; determining values for the components for locations in the GROI for a plurality of times in a first period of time; and using the values of the components to provide a measure of an intensity of the transportation need in the GROI for a second period of time.

Optionally, the values of the components determined for the first time period comprises determining a spatiotemporal service need feature (SNEF) vector for each of a plurality of times during the first time period. Optionally, the method comprises using the SNEF vectors determined for the plurality of times in the first time period to determine a time resolved regression function for the SNEF vectors. Optionally, the method comprises using the regression function to determine an anticipated SNEF vector for a time in the second time period and using the anticipated SNEF vector to provide the measure of the transportation need for the second time period. Optionally, providing the measure comprises determining a value of a scalar product of the anticipated SNEF vector with a weighting vector and using the value to provide a numerical measure of the intensity of the need for the given time and location. Additionally or alternatively, providing the measure of the intensity of the transportation need may comprise processing the anticipated SNEF vector with a neural network. Optionally, the neural network provides a probability distribution for the intensity of the transportation need having a particular value of a plurality of values.

In an embodiment the method comprises for each of the SNEF vectors determined for the first time period determining a scalar product of the SNEF vector with a weighting function. Optionally, the method comprises using the determined scalar products to determine a time resolved regression function for the scalar products in the first time period. Optionally, the method comprises using the regression function to provide an anticipated value for a scalar product of a SNEF vector and weighting function at a time in the second time period and using the anticipated value to provide a measure of an intensity of the transportation need in the second time period.

In an embodiment providing the measure of intensity of the transportation need for the second period of time comprises determining a time resolved regression function for at least one of the components. Optionally, the method comprises using the regression function to determine the measure for the second period of time.

In an embodiment the method comprises processing the values of the components to determine at least one spatiotemporal zone of interest (ZOI) in the GROI that exhibits the transportation need for locations in the ZOI as a function of time. Optionally, determining the measure of the intensity of the transportation need for GROI for the second period of time comprises determining the measure of intensity for the at least one ZOI.

In an embodiment the method comprises deploying TOD vehicles to service the transportation need during the second period of time responsive to the measure.

There is further provided in accordance with an embodiment a mobility as a service (MaaS) management system for managing provision of TOD vehicles to service transportation needs of a population of users comprising computer executable software executable to perform a method in accordance with an embodiment of the disclosure.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the disclosure in the present application are provided by way of example and are not intended to limit the scope of the disclosure. The described embodiments comprise different features, not all of which are required in all embodiments of the disclosure. Some embodiments utilize only some of the features or possible combinations of the features. Variations of embodiments of the disclosure that are described, and embodiments of the disclosure comprising different combinations of features noted in the described embodiments, will occur to persons of the art. The scope of the invention is limited only by the claims.

1-16. (canceled)

17. A non-transitory computer-readable medium including instructions that when executed by at least one processor cause the at least one processor to perform operations for anticipating a demand for transportation-on-demand vehicles operating in a geographical region of interest, the operations comprising:
determining a plurality of spatiotemporal service need feature vectors characterizing a transportation need in the geographical region of interest over a first time period, wherein each spatiotemporal service need feature vector includes components associated with at least one of: the transportation need, a time within the first time period, or a location within the geographical region of interest;
determine a time-resolved regression function based on the plurality of spatiotemporal service need feature vectors;
applying the time-resolved regression function to determine, from the plurality of spatiotemporal service need feature vectors, a plurality of anticipated spatiotemporal service need feature vectors for a second time period subsequent to the first time period; and
using the plurality of anticipated spatiotemporal service need feature vectors to determine a measure of anticipated transportation need in the geographical region of interest for the second time period.

18. The non-transitory computer-readable medium of claim 17, wherein determining the measure of anticipated transportation need in the geographical region of interest for the second time period includes determining a scalar product between the plurality of anticipated spatiotemporal service need feature vectors and a weighting vector.

19. The non-transitory computer-readable medium of claim 17, the operations further comprising processing the anticipated spatiotemporal service need feature vector using a neural network.

20. The non-transitory computer-readable medium of claim 19, wherein the neural network is configured to provide a probability distribution for the measure of anticipated transportation need in the geographical region of interest for the second time period.

21. The non-transitory computer-readable medium of claim 17, the operations further comprising determining a scalar product between each spatiotemporal service need feature vector and a weighting function for the first time period.

22. The non-transitory computer-readable medium of claim 21, wherein the time-resolved regression function is determined based on the scalar product between each spatiotemporal service need feature vector and the weighting function.

23. The non-transitory computer-readable medium of claim 21, the operations further comprising using the time-resolved regression function to provide an anticipated value for a scalar product between the anticipated spatiotemporal service need feature vectors and the weighting function, wherein the measure of anticipated transportation need in the geographical region of interest for the second time period is further based on the anticipated value for the scalar product.

24. The non-transitory computer-readable medium of claim 17, wherein the time-resolved regression function is associated with at least one of the components of the plurality of spatiotemporal service need feature vectors.

25. The non-transitory computer-readable medium of claim 17, the operations further comprising processing the spatiotemporal service need feature vectors to determine at least one spatiotemporal zone of interest in the geographical region of interest exhibiting the transportation need for locations in the zone of interest as a function of time.

26. The non-transitory computer-readable medium of claim 25, wherein determining the measure of anticipated transportation need in the geographical region of interest for the second time period includes determining the measure of anticipated transportation need for the at least one spatiotemporal zone of interest.

27. The non-transitory computer-readable medium of claim 17, further comprising deploying multiple transportation-on-demand vehicles to service the transportation need during the second time period responsive to the measure of anticipated transportation need.

28. The non-transitory computer-readable medium of claim 17, wherein the transportation need is associated with a first-mile-last-mile transportation need.

29. The non-transitory computer-readable medium of claim 17, the operations further comprising tiling the geographical region of interest with a plurality of virtual tiles, each tile assigned to a geographic location in the geographical region of interest and having a geographic area defined by a tile boundary, wherein each service need feature vector corresponds to a different one of the tiles.

30. The computer-readable medium of claim 17, the operations further comprising monitoring a plurality of trips in the geographical region of interest, wherein each of the plurality of service need feature vectors corresponds to a different one of the plurality of trips.
